(19) United States
(12) Patent Application Publication
(10) Pub. No.: US 2007/0215497 A1
(43) Pub. Date: Sep. 20, 2007

(54) Glove pair dispensing system

(76) Inventors: Kiran K. Reddy, Roswell, GA (US); Malcolm Daniel Poirier, Talking Rock, GA (US); Jason Alan Baker, Alpharetta, GA (US); Stephanie Ann Rossignol, Cumming, GA (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/276,969

(22) Filed: Mar. 20, 2006

(51) Int. Cl. B65D 85/18; B65G 59/00

(52) U.S. Cl. 206/278; 221/282

(57) ABSTRACT

An assembly for containing and dispensing a glove pair is disclosed. The assembly is a glove pair contained within and protected by an individual pouch. The pouch is relatively small in size such that the assembly is easy for the user to transport to the place and time that the user desires to use the gloves within the pouch. Various indicia may be included with the pouch to help differentiate the type of gloves contained within the pouch or to indicate how the pouch is to be opened. A system for containing and dispensing packaged glove pairs is also disclosed. The system may include a dispensing container that contains and dispenses glove pairs enclosed in individual pouches. Instructions may be included to help the user select the appropriate gloves to meet their needs and help them select the appropriate pouch containing the appropriate gloves from amongst a plurality of pouches containing different types of gloves.

### BACKGROUND

Protective gloves are commonly used by medical personnel (such as doctors, nurses, dentists and emergency workers), food service personnel, sanitation personnel, maintenance personnel and many others, in order to protect themselves and others from contaminants and diseases such as hepatitis B and acquired immune deficiency syndrome (AIDS) to name just a few. Such gloves are expected to provide a barrier between the wearer and the environment with which the glove comes in contact. For the cleanliness and protection of the wearer and those whom the wearer contacts, such gloves are meant to be disposable. As used herein, “disposable” refers to the gloves being designed to be thrown away after a single use or after a finite number of uses or time period.

Such disposable gloves are well known in the art and come in a multitude of varieties for a myriad of purposes. Various levels of protection are provided with glove substrates such as plastic, rubber latex, nitrile rubber, and the like, and by having different substrate thicknesses. Some disposable glove pairs are sterilized, such as used for medical procedures. Disposable gloves are also available with various donning aids, lubricants, powders, textures, medicants, disinfectants, and other additives or designs that add functionality to the disposable gloves to meet the needs of a particular user.

Often such disposable gloves are made available to the user in a larger number. Such gloves are often stacked, folded, rolled or more often randomly stuffed into a carton or dispenser. The user then dispenses individual gloves to themselves by retrieving the gloves they need from such dispensers.

However, such mass-dispensing can be problematic for a multitude of reasons. For instance, when stuffed, stacked or otherwise grouped together, the disposable gloves will often “block”, or stick together, and make dispensing an individual glove difficult, if not impossible. Additionally, more gloves than needed will often be dispensed to the user, leading to a waste of gloves and the associated costs that naturally extend to such waste.

Such mass-dispensing also raises concerns regarding sanitation. It is understandable that it is desired that the undispensed gloves be kept sanitary prior to their use. However, two distinct issues are raised by the common methods of mass-dispensing from a carton or dispenser. First, with mass-dispensing the user often has to insert their hand, at least partially, into the dispenser to retrieve the gloves that they need. Their hands may contain contaminants that will likely come into contact with multiple gloves within the dispenser and consequently may pass those contaminants to subsequent users of these stored gloves.

Secondly, mass-dispensing also has a sanitation issue with dispensing in an open environment. Such dispensers have a dispensing opening that exposes the gloves for dispensing, but also exposes such gloves to contaminants that may be present in the environment. Sprayed water or other fluids, sneezes, coughs, or other environmental factors may contaminate gloves that are exposed in such open- or semi-open dispensers.

Another problem with traditional methods of dispensing disposable gloves is that the gloves are stored in central location. If a user wants to get a clean pair of gloves they must return to the dispenser to retrieve the gloves or otherwise take additional pairs of gloves with them for later use. Similarly, those users that desire to use gloves outside the environment in which the gloves are stored and supplied must also transport extra gloves. Such mass-dispensing options are not easily transportable to all of the locations that such gloves may be needed. For example, a doctor may store extra pairs of gloves in the pockets of their coat or an emergency medical technician may have to store a pair of gloves in their medical kits for use when out of the hospital environment.

Similarly, law enforcement officers, security personnel and firemen often encounter situations in field operations where they need such protective gloves. Such personnel will often keep a pair of gloves on their duty belt or otherwise store them in their clothing, thus exposing the gloves to the environment and the everyday wear and tear of a user's daily activity. Mass-dispensing options do not provide such users with a convenient sanitary glove solution for their needs. Additionally, sterile flat-packaged options that are commonly available for such gloves inefficiently take up more space than the gloves contained within such packaging and are not conducive to easy storage and transport.

Even in executions where the sanitary nature of the gloves is less important, such as disposable gloves for home improvement projects, disposable gloves can be unwieldy to store and transport. The flexible nature and texture of the gloves make them awkward to store and the gloves can often can become damaged if thrown in a pocket, a tool chest, or other such loose storage.

Others have sealed individual gloves in individual packaging, but none of these solutions have addressed the issue of easy portability of a glove pair. Nor has any of the previous solutions provided easy portability of a sterile glove pair for easy use at the location of the user's choosing.

### SUMMARY OF THE INVENTION

In light of the problems and issues discussed above, it is desired to have a glove pair dispensing system that would allow for sanitary dispensing of individual glove pairs without the blocking, waste, or sanitation issues common with current glove dispensing systems. Additionally, it is desired for a user to have ability to easily and sanitarily transport such glove pairs to the time and place that the user chooses. Furthermore, it is desired that a variety of gloves be made available to the user in convenient packaging that is easily differentiable such that a user can easily select the gloves pair that meets their needs.

The present invention is directed to an assembly for containing and dispensing a glove pair. The assembly is made up of a compacted glove pair that is contained and protected within a pouch made from a protective wrap. The assembly of the invention additionally may have a separator that separates the gloves of the glove pair. Additionally, or alternatively, the assembly may have an opener that facilitates the opening of the pouch. The assemblies may have indicia, such as opening indicia or differentiating indicia, associated with the assemblies. Finally, the assemblies may be contained and dispensed from a dispensing container. Such a dispensing container may additionally have a mount to non-permanently affix the dispensing container to a surface.

The invention is also directed to a system for containing and dispensing packaged glove pairs. The system is made up of compacted glove pairs packaged within pouches and those pouches being stored and dispensed from an interior compartment of a dispensing container. The dispensing container may include a mount that non-permanently affixes the dispensing container to a support surface. Such a mount may be a part of the dispensing container or may be a bracket that is affixed to the support surface and into which the dispensing container may be placed. Additionally, the mount may be adapted to non-permanently affix more than one dispensing container to a support surface.

The system of the invention may further include a second type of gloves that are packaged in a second set of pouches. In such a system, the dispensing container may additionally have a second interior compartment to contain and dispense such a second set of pouches. Alternatively, the second set of pouches may be stored and dispensed from a second dispensing container. In systems with more than one dispensing container, the mount used to non-permanently affix the containers to a support surface may be adapted to affix more than one dispensing container.

Finally, the invention is directed to a system for providing glove pairs to a user. The system has a first type of glove pairs contained in pouches and a second type of glove pairs contained in different pouches, where the pouches have differentiating indicia that indicates the type of glove pair within the particular pouch. The system also includes a set of instructions that help the user select the appropriate glove pair type. The system may also include a dispensing container having multiple interior compartments to contain and dispense the different types of pouches or the system may include multiple dispensing containers, each containing a different type of pouch. In such cases, the instructions may associated with the dispensing container(s).

### BRIEF DESCRIPTION OF THE DRAWINGS

FIG. 1 is a perspective view of an exemplary glove pair assembly of the present invention,

FIG. 2 is a perspective view of a partially opened pouch revealing a glove pair contained within the glove pair assembly of FIG. 1,

FIG. 3 is a perspective view of another exemplary glove pair assembly of the present invention,

FIG. 4 is a perspective view of the pouch of the assembly of FIG. 3 partially opened to reveal a single glove according to the present invention,

FIG. 5 is a cross-sectional view of an assembly of the present invention and showing a separator separating the gloves of a glove pair according the present invention, and

FIG. 6 is a perspective view of an exemplary dispensing container of the present invention.

### DETAILED DESCRIPTION

Reference will now be made in detail to various embodiments of the invention, one or more examples of which are illustrated in the drawings. Each example is provided by way of explanation of the invention and is not meant as a limitation of the invention. For example, features illustrated or described as part of one embodiment can be used in another embodiment to yield still a further embodiment. It is intended that the present invention covers such modifications and variations coming within the scope and spirit of the invention.

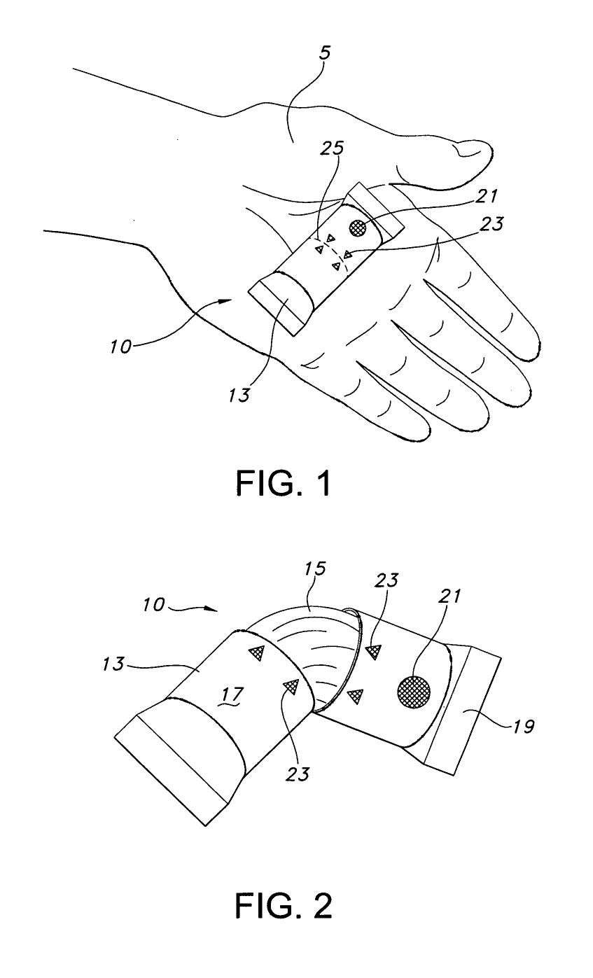

In general, FIGS. 1-5 illustrate the glove pair assembly 10 of the present invention. A glove pair 15 is made up of a first glove 51 and a second glove 52 that are compacted and packaged within a pouch 13 to form the glove pair assembly 10. The pouch 13 both contains and protects the glove pair 15 and allows for easy transport of the assembly 10 to the time and place of user's choosing. The user may then open the pouch 13 and utilize the glove pair 15 within the pouch 13.

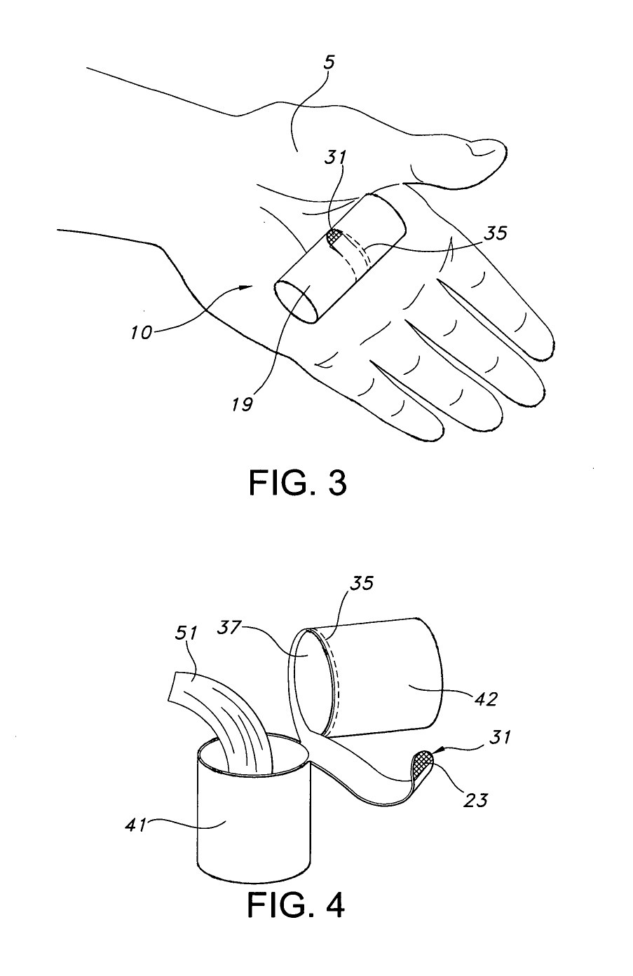

The assembly 10 is intended to be of a size that is easily handled and transported by a user. As shown in the FIGS. 1 and 3, the assembly 10 is shown as easily fitting the in the palm 5 of a user. The compact size of the assembly 10 makes it easy for a user to keep and transport the assembly 10 in a pocket, purse, medical kit, or other convenient location. Additionally, such a compact size allows the user to grab multiples of such assemblies 10 in their hand. However, the size shown in FIGS. 1 and 3 is only one example of the size of the assemblies 10 of the present invention and is not intended to be limiting. The assembly 10 may be larger or smaller than shown; the assembly 10 may be any size that meets the needs of the user and the glove pair 15 contained within the pouch 13.

The pouch 13 of the assembly 10 is intended to contain and protect the glove pair 15. The pouch 13 is made of a protective wrap 17 that may be made of any material adapted for the needs of the particular pouch. Generally, the pouch may be made of paper, plastic, cardstock, cardboard, composite materials, nonwovens, laminates or the like. Such protective wrap 17 materials may additionally be coated on the interior, exterior, or both the interior and exterior, to provide additional functionality to the pouch 13. The protective wrap 17 may be a flexible material or may be a rigid material. If the glove pair 15 is to be sterilized while enclosed within the pouch 13, the protective wrap 17 would need to be compatible with the sterilization technique to be used. Optionally, the protective wrap 17 may be made of a material that would allow the assembly 10 to be cleaned with water or alcohol prior to opening the pouch 13.

The shape of the pouch 13 is generally tubular with closed ends 19. The pouch 13 may be symmetrical or asymmetrical. Additionally, the cross-sectional shape of the pouch may be any shape, symmetrical or asymmetrical, that can contain the glove pair 15.

Any method, as are well known, may be used to form the tubular shape and seal the ends 19 of the pouch 13. The ends 19 of the pouch 13 may be sealed by any method, such as, heat sealing, adhesive sealing, crimping, fasteners, or the like, that will provide a sterile seal that will not easily open during transport and will keep the glove pair 15 separated from the environment external to the pouch 13.

The cross-sectional shape of the end 19 of the pouch 13, may be a variety of shapes depending on the packaging equipment, the needs of the user, and design choice. For example, in FIGS. 1 and 2 the ends 19 of the pouch 13 are shown as flat. Alternatively, the ends 19 of the pouch 13 shown in FIGS. 3 and 4 are generally circular in shape. The actual shapes of the ends, may be any symmetrical or asymmetrical shape that is desired. By way of non-limiting examples, the ends 19 may be square, trapezoidal, rectangular, multi-pointed star, or other distinctive shapes. Additionally, the opposite ends 19 of the pouch 13 may have the same shape or they may have different shapes.

The pouch 13 may be seamless or may be made of various sections of protective wrap 17 that are joined together. The pouch 13 may be formed by rolling protective wrap material to form a tube followed by sealing the ends 19 of the formed tube to make the pouch 13. The end flap of the protective wrap material 17 could be sealed to the proceeding wrap of the protective wrap material 17 by any means as is know to seal materials to like materials such as thermal seal, adhesive bonds, or other similar methods. Again, the purpose of the seal is to keep the glove pair 15 contained within the pouch 13 sanitary and separated from the environment outside of the pouch 13 and to keep the pouch 13 sealed through transport and normal use of the pouch 13.

The pouch 13 may additionally have an opener to allow for easy opening of the pouch 13 to give access to the glove pair 15 contained therein. Such an opener may be any feature that allows such access when actuated, but maintains the integrity of the pouch 13 prior to such actuation. For example, FIG. 1 shows an opener that is an area of weakness 25 that at least partially circumscribes the mid-section of the exemplary pouch 13. This area of weakness 25 may be a line of perforations, a scoring, a section of weaker material in the protective wrap 17, or other weakening of an area, circumference, or part of the circumference, of the protective wrap 17 that allows the protective wrap 17 to be broken when the opener is so actuated.

In the example shown in FIG. 1, the pouch 13 may be twisted or bent in half from the ends 19 such that the area of weakness 25 in the mid-section of the pouch 13 is ruptured. The resulting break, as shown in FIG. 2, reveals the glove pair 15 which may now be removed from inside the pouch 13.

Another example of an opener is shown in FIG. 3 where the opener is shown as a pull tab 31 located on the surface of the pouch 13 that may be pulled to tear the protective wrap 17. The pull tab 31 shown in FIGS. 3 and 4 is associated with lines of weakness 35 that assist the pull tab 31 in tearing the protective wrap 17. Such lines of weakness 35 may be perforations, areas of weakened material, scoring, or the like. Alternatively, the pull tab 31 may not be associated with any lines of weakness and may instead tear the protective wrap 17 open in a more random fashion.

In a further embodiment, the pull tab 31 may be a part of a tear strip. Such a tear strip may be integrated into the protective wrap 17 and aid in the tearing of the protective wrap 17 when the pull tab 31 is pulled. The tear strip is desirably formed by a tape, line, rope, and so forth, containing strong fibers within it. The tear strip may be formed from a number of different materials, such as, but not by way of limitation, natural or synthetic fiber, plastic, metal wire, any combination(s) thereof, and so forth. The tear strip may be attached to the protective wrap 17 by any method, such as, by way of non-limiting example, adhesive, heat sealing, ultrasonically sealing, laminating, integrally formed with the protective wrap 17, and so forth.

The openers 25,31 shown in FIGS. 1-4 are examples of just two possible openers and are not intended to be limiting. The opener may be any structure that allows for the easy opening of the pouch 13 once it is actuated. Additionally, the openers shown in these examples were shown in the mid-section of the pouches 13 for the ease of illustration. The openers may be centered, as shown, or may be off-center, or even incorporate the ends 19 of the pouch 13. The opener may open the pouch 13 about its width, as shown in FIGS. 1-4, or may open the pouch 13 along its length. Additionally, more than one opener may be available on a single pouch 13.

The gloves that are packaged as glove pairs 15 as a part of the present invention may be any type of glove as are well understood in the art. Such gloves may include gloves that are commonly referred to as “protective gloves”, “surgical gloves”, “surgeon's gloves”, “medical gloves”, “examination gloves”, “disposable gloves”, “safety gloves”, “food service gloves”, “cleaning gloves”, and the like. The gloves are preferably disposable, but they may be designed for one-time use or may be designed to be used a discreet number of times or for a discrete length of time before being disposed. The gloves may be made from natural or synthetic materials and the materials may be elastic or non-elastic. Such gloves may be made from materials, such as plastic, latex, nitrile, vinyl, vinyl/PVC, polyethylene, natural rubber, neoprene, composite materials or the like.

The gloves of the present invention may be made in various sizes to accommodate various hand sizes. The gloves may be hand-specific or they may be ambidextrous. Additionally, the gloves may cover only the hand and palm, or the cuff of the gloves may extend up the arm of the user. Such cuffs may be loose fitting or they may be elasticized.

Additional functionality may be added to the gloves depending on the needs of the end users. For example, the gloves may have donning aids, lubricants, powders, textures, medicants, disinfectants, and other additives or designs associated with the interior or exterior surfaces of the glove that add functionality to the disposable gloves to meet the needs of a particular user.

The gloves may be non-sterilized or they may be sterilized by any of the known sterilization methods for such gloves. Such sterilization of the gloves may be performed on the gloves prior to insertion into the pouches 13 or the glove pairs 15 may be packaged within a pouch 13 prior to the entire assembly 10 being sterilized.

The glove pairs 15 that are contained in the pouch 13 to make up the assembly 10 are compact. As used herein, “compact” or “compacted”, refers to the characteristic of the packaged glove pairs 15 taking up an economical area by nature of having been folded, rolled up, compressed, wadded up, or any other method, or combination of methods, for reducing the space the glove pairs 15 inhabit within the pouch 13 from the space they inhabited in a flattened form or will inhabit in use. A non-limiting example of the formation of such a compact glove pair 15 is a flat pair of gloves that are first laid one on top of the other, the glove pair 15 may then be folded in half, and finally the folded glove pair 15 may then be rolled up tightly. The resultant rolled glove pair 15 can then be packaged in a pouch 13 with a much smaller footprint than the package that would be required to package the flattened glove pair.

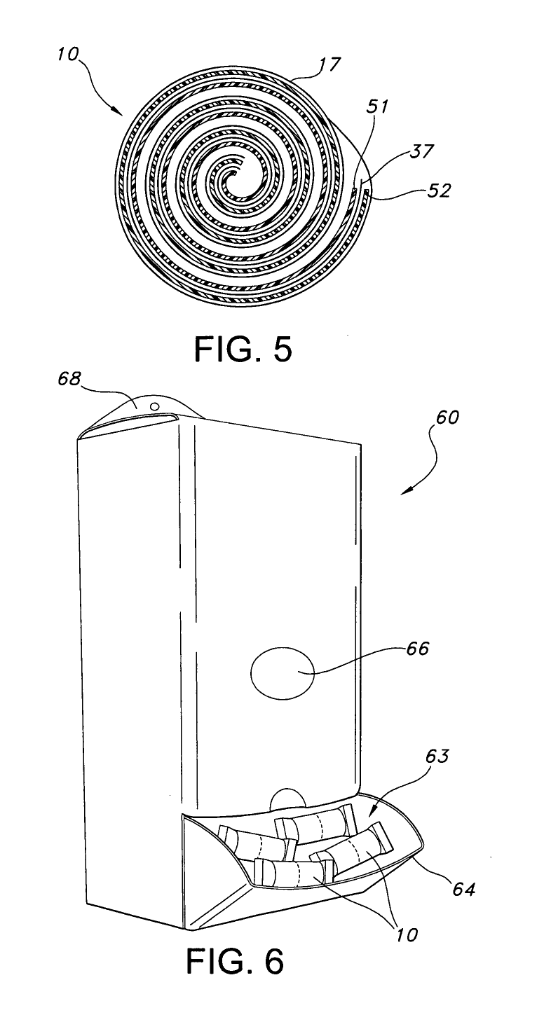

The compact glove pairs 15 are packaged in a pouch 13 by any means appropriate for the compact glove pair 15, and associated pouch 13, as desired. The compacting and packaging of the glove pairs 15 may be separate processes or they may be part of the same process. For example, the glove pair 15 may be rolled up along with the protective wrap material 17. The protective wrap material 17 may then be sealed to itself and on the ends to form a pouch 13 with the glove pairs 15 rolled up inside. FIG. 5 shows a cross-sectional view of a pouch 13 that may have been made by such a packaging process.

Optionally, the glove pair dispensing system may also include a separator 37 to separate the gloves of the glove pair 15. A separator 37 is especially helpful when the gloves of the glove pair 15 have a tendency to stick together due to the glove substrate, static electricity, substances present on the gloves, or for other similar reasons. The separator 37 may be the same material as the protective wrap 17 that makes up the pouch 13 or may be a different material. Whatever the material of the separator 37, it must be compatible with the glove pair 15 and any lotion, medicant, coating or other substance that may have been added to the gloves.

The separator 37 may be used in any fashion within the assembly to separate the gloves of the glove pair 15. As shown in FIG. 5, the separator 37 may be rolled up between a first glove 51 and a second glove 52, along with the protective wrap 17, in order to form the assembly 10. Alternatively, the separator 37 may be an interior wall within pouch 13 that splits the pouch 13 either length-wise or width-wise, as shown in FIG. 4, to form separate compartments within the pouch 13.

As shown in FIG. 4, the separator 37 may work with the placement of the opener, such that when the opener is actuated, the pouch 13 is opened on one side of the separator 37. This would allow for the first glove 51 to be dispensed from the opened portion 41 of the pouch 13, while the second glove 52 remains protected in an unopened portion 42 of the pouch 13, on the other side of the separator 37. Continued actuation of the opener may then remove the separator 37 or otherwise open the remaining portion of the pouch 31.

In the case of the assembly 10 of FIGS. 3 and 4, the line of weakness 35 circumscribes the pouch 13 more than one turn. When the tab 31 is pulled, one end 41 of the pouch 13 is opened and the first glove 51 may be removed. If the tab 31 is continued to be pulled around the pouch 13, the unopened end 42 of the pouch 13 will also be opened. An alternative embodiment would incorporate a second opener 37 into the pouch 13 such that actuation of the second opener 37 would reveal the second glove 52 on the other side of the separator 37.

The glove pair dispensing systems may additionally include indicia that may be used to instruct the user in the manner of use for the system, may differentiate types of glove pairs 15 contained within various pouches 13, or may provide both such functionalities. Such indicia may be any word(s), numeral(s), line(s), symbol(s), picture(s), physical shape(s), color(s), texture(s) and/or combination(s) thereof, and so forth, which communicates to the user a desired message.

One type of indicia that may be used with the glove pair system are opening indicia 23 that communicate to the user the message of how the particular pouch 13 is to be opened to access the glove pair 15 inside. Such opening indicia 23 may be on the body of the pouch 13, on the opener (if present), or present on both. For example, as shown in FIGS. 1 and 2, the opening indicia 23 may be arrowheads that point to the area of weakness 25.

As shown in FIGS. 3 and 4, another opening indicia 23 may be a pull tab 31 that is differently colored than the protective wrap on which it rests. Additionally, a second opening indicia (not shown) such as the word “PULL” and a directional arrow may also be included to fully convey the message of the method of opening the pouch 13. One skilled in the art can see that there are multiple possible opening indicia 23, and combinations of opening indicia 23, that may be used to communicate a message to user as to the method of opening the pouch 13.

Another type of indicia that may be incorporated into the glove pair system are differentiating indicia 21 that may be used to communicate to the user the particular type of glove pair 15 that is contained within the pouch 13. Such differentiating indicia 21 may be particularly helpful when multiple types of glove pairs 15 with various attributes are packaged in pouches 13 of the present invention. Such glove pairs 15 may have different sizes, glove substrates, coatings, sterilization, and the like, as previously discussed. Due to the relatively compact nature of the pouches 13, simple descriptions of the glove pair 15 contained within the pouch 13 may not easily differentiate one glove pair assembly from a different glove assembly. Differentiating indicia 21 may be used to more clearly differentiate different types of glove pairs to allow the user to quickly, easily and correctly select the assembly 10 that they desire for their particular needs.

An example of such differentiating indicia 21 may be different colors of protective wraps 17, or patches of such colors on the protective wraps 17, to be associated with different sizes of glove pairs 15. For example, a pair of “small” gloves may be packaged in an light blue pouch while a pair of “large” gloves may be packaged in a green pouch. Alternatively, or additionally, different large symbols (as shown in FIGS. 1 and 2) that are clearly distinguishable at a glance may be printed on the protective wrap 17 to differentiate pouches 13 containing one type of glove (e.g., latex gloves) from pouches 13 containing a different type of glove (e.g., nitrile gloves).

Another possible differentiating indicia 21 may be patches of texture on a pouch 13. For example, and assembly 10 containing a lubricated pair of gloves may have a rough textured pattern on the protective wrap 17 while gloves without such lubricant may be differentiated by being packaged in a smooth-textured protective wrap 17.

The differentiating indicia 21 may be the structure of the pouch 13 itself. One type of glove pair 15 may be differentiated from a different type of glove pair by the opener that is employed (e.g., pouches 13 with pull tabs 31 versus pouches 13 with areas of weakness 25). Alternatively, the nature of the end seal 19 may be used to differentiate glove types (e.g., pouches 13 having a flat end versus a 4-point star shaped end versus a 3-point star shaped end).

The differentiating indicia 21 discussed here are only intended to give examples of such indicia and are not intended to be limiting. One skilled in the art can see how these, and other, differentiating indicia 21 could be used to communicate to the user the type of glove pair 15 contained within the pouch 13. One skilled in the art can also see how various differentiating indicia 21 may be used separately, or in combination, to help easily differentiate various types of glove pairs 15 that may be contained in various pouches 13.

It may be desirable to supply the user with a plurality of glove pair assemblies of various types that form a matrix of gloves that meets the needs of a matrix of specific applications. Different combinations of glove characteristics (i.e., size, glove substrate, lubricant, sterility, etc.) may be produced and packaged in pouches according to this invention. Differentiation indicia 21 on such a variety of assemblies 10 would then provide the lo user with the ability to select the appropriate glove pair assembly 10 quickly and efficiently. To support the quick and efficient selection of the appropriate glove pair assembly, instructions may be included with the variety of glove pair assemblies 10. The instructions could help the user match up glove attributes with the various differentiation indicia 21 being employed. Such instructions may also include a selection guide that would help the user match up the appropriate type of glove for a particular application or use.

The glove pair assemblies 10 of the present invention may additionally be contained and dispensed from a dispensing container 60. Such a dispensing container 60 may be a disposable container that is used to both contain the assemblies 10 during shipment and storage, but may also be used to dispense the assemblies 10 to the user. Preferably, the dispensing container 60 is a disposable, non-refillable container. As shown in FIG. 6, the dispensing container 60 may be adapted to be affixed to a vertical support surface and the assemblies 10 may then be dispensed from a dispensing opening 63. Alternatively, or additionally, the dispensing container 60 may be adapted to dispense from a horizontal surface.

Generally, the dispensing container 60 has an internal compartment which contains the assemblies 10 prior to and during dispensing. The internal compartment is associated with a dispensing opening 63, through which the assemblies 10 are dispensed. The dispensing opening 63 of the dispensing container 60 may be in the form of a dispensing chute 64, as shown in FIG. 6, but may be a simple opening in the wall of the dispensing container 60, a tray, or the like. A secondary opening 66 may be included in a wall of the dispensing container 60 so that the user can see into the interior of the dispensing container 60 to determine how many assemblies 10 remain to be dispensed. Such a second opening 66 may help the user gauge when a new dispensing container 60 will be needed.

The dispensing container 60 may be made of any material that can contain and dispense the assemblies of the present invention. Preferably, the dispensing container 60 may be made of heavy paper, cardboard or plastic, but it may be made of any other suitable material within the scope of the invention.

Optionally, the dispensing container 60 may have a plurality of internal compartments within the dispensing container 60 where each of the compartments contains a different type of glove pair assembly 10. Separate individual dispensing openings 63 may be associated with each of the internal compartments. For example, a single dispensing container may have three compartments with a separate dispensing opening for each compartment. The first lo compartment may contain and dispense glove pair assemblies containing “small” glove pairs, the second compartment may contain and dispense glove pair assemblies containing “medium” glove pairs, and the third compartment may contain and dispense glove pair assemblies containing “large” glove pairs. Other combinations of glove attributes, such as previously discussed, may be included in dispensers having multiple compartments. The design of the dispensing container 60, including number of compartments and dispensing orientation (i.e., vertical or horizontally oriented), and the glove pair assemblies included in such dispensing containers 60 may be adapted for the particular needs of the user. One skilled in the art can see how other designs and features may be combined to form the dispensing containers 60.

The dispensing container 60 may be designed to non-permanently attach to a support surface. As used here, the term “non-permanently” refers to the attribute that the dispensing container 60 may be attached to a support surface, detached, and reattached to the surface, repeatedly, during the limited use-life of the dispensing container 60. The support surface may be any surface that when a dispensing container 60 is affixed to it will allow the assemblies 10 to be dispensed. For example, the support surface may be, but is not limited to, a wall, a door, a post, a pole, a dispenser affixed to a wall or embedded into a wall, a table, a countertop, or the like. However, the means for attachment must also be strong enough and configured in such way that the dispensing container 60 is secured to the surface while assemblies 10 are dispensed from the dispensing container 60.

Various mounts may be used to non-permanently affix the dispensing container 60 to a support surface. For example, as shown in FIG. 6, the dispensing container 60 may be affixed to the support surface with mounting tab 68 near the top of the dispenser. As shown in FIG. 6, such a tab 68 may affix the dispensing container 60 to a vertical support surface by a fastener that passes through the tab 68 into the vertical support surface. Alternatively, or additionally, the dispensing container 60 may be affixed to the surface with adhesive strips, hook-and-loop type fasteners, or the like that are present on the back of the dispensing container 60, on the surface, or on the combination of the surface and the back of the dispensing container 60.

Finally, the mount may be adapted to cooperate with a bracket that is installed on the support surface such that a disposable dispensing container 60 containing the glove pair assemblies 10 may associate with and be supported by the bracket. For example, the bracket may be a sleeve affixed to wall and sized such the dispensing container 10 may be dropped into the bracket; the glove pair assemblies 10 may be dispensed from the dispensing container 60 within the bracket; and then the empty dispensing container 60 may be removed from the bracket sleeve and disposed. Alternatively, the bracket may be adapted to fit into openings in the back of the dispenser container 60 or any other design that can secure the dispensing container 60 while assemblies 10 are dispensed.

Such bracket installations may be such that various dispensing containers 60, each containing a single type of glove pair assembly 10, may be associated in close proximity to each another. For example, the bracket may affix three dispensing containers 10 to the surface next to each other (e.g., place dispensers having “small”, “medium”, and “large” sized gloves pairs next to each other). Such a bracket could provide the user with a variety of gloves and would allow for the replacement of dispensing containers 60 of a particular type of glove pair assemblies 10 that are consumed before the glove assemblies 10 in other dispensing containers 60 are fully consumed. One skilled in the art would be able to see how other mounts on containers 60 and brackets may be used individually or in combination to provide the user with different glove assembly dispensing options including one or more dispensing containers 60.

As with the assemblies 10, the dispensing container 60 may also have indicia that help the user select the dispensing container 60 containing the desired glove pair assemblies 10. For example, if differently colored protective wraps 17 were used as differentiating indicia 21 to differentiate various sizes of glove pairs contained with their respective assemblies 10, the respective dispensing containers 60 could also be printed with the same color as the assemblies 10 inside the container.

Additionally, the dispensing containers 60 or the mounting brackets may have indicia that help communicate to the user the proper operation of the dispensing container 60. This may include symbols, words, diagrams or the other such indicia that help communicate to the user the proper method of installation, use, indication of need for replacement, disposal, or other such operational aspects of the container 60. The dispensing container 60 may also include instruction on the proper use of the assemblies 10 contained therein.

Finally, any instructions that are included with the system that help the user identify the proper glove pair 15 for their particular use and/or instructions as to use of the differentiating indicia 21 may be associated with the dispensing container 60 or a mounting bracket used to mount such a container 60. Such instructions may be printed on the dispensing container(s) 60, may be on the mounting bracket, may be in close proximity to the dispensing container, or at some other location associated with the dispensing system.

It will be appreciated that the foregoing examples and discussion, given for purposes of illustration, are not to be construed as limiting the scope of this invention, which is defined by the following claims and all equivalents thereto.

1. An assembly for containing and dispensing a glove pair comprising:
a compacted glove pair, comprising a first glove and a second glove, and
a pouch comprising a protective wrap,
wherein the pouch contains and protects the compacted glove pair from the environment external to the pouch.

2. The assembly of claim 1, further comprising a separator within the pouch that separates the first glove from the second glove.

3. The assembly of claim 2, wherein the first glove and the second glove are rolled up with the separator, and wherein the separator is positioned between the first glove and the second glove.

4. The assembly of claim 2, wherein the pouch is configured to be partially opened such that the first glove may be removed while the second glove is protected by an unopened portion of the pouch and the separator.

5. The assembly of claim 1, further comprising an opener associated with the pouch, wherein the opener is configured to facilitate opening of the pouch.

6. The assembly of claim 5, wherein the opener comprises an area of weakness associated with the protective wrap.

7. The assembly of claim 5, wherein the opener comprises a pull tab.

8. The assembly of claim 5, wherein the opener comprises a tear strip associated with the protective wrap.

9. The assembly of claim 5, further comprising at least one opening indicia.

10. The assembly of claim 9, wherein the opening indicia is present on the pouch.

11. The assembly of claim 9, wherein the opening indicia is present on the opener.

12. The assembly of claim 1, further comprising at least one differentiating indicia.

13. A dispenser to contain and dispense a plurality of the assemblies of claim 1, the dispenser comprising a dispensing container and a dispensing opening.

14. The dispenser of claim 13, further comprising a mount, the mount configured to non-permanently affix the dispensing container to a support surface.

15. A system for containing and dispensing packaged glove pairs, the system comprising:
a first dispensing container;
a first plurality of pouches, each pouch of the first plurality of pouches comprising a protective wrap; and
a first plurality of compacted glove pairs, each compacted glove pair of the first plurality of compacted glove pairs comprising a first glove and a second glove,
wherein each compacted glove pair of the first plurality of compacted glove pairs is contained within a pouch of the first plurality of pouches,
wherein the first dispensing container comprises a first interior compartment and a first dispensing opening associated with the first interior compartment, and
wherein the first plurality of pouches are stored within the first interior compartment and are dispensed from the first interior compartment through the, first dispensing opening.

16. The system of claim 15, further comprising a mount, the mount configured to non-permanently affix the dispensing container to a support surface.

17. The system of claim 16, wherein the mount is positioned on the dispensing container.

18. The system of claim 16, wherein the mount is a bracket affixed to the support surface and into which the dispensing container may be placed.

19. The system of claim 16, wherein the mount is adapted to non-permanently affix more than one dispensing container to the support surface

20. The system of claim 15, further comprising:
a second plurality of pouches, each pouch of the second plurality of pouches comprising a protective wrap; and
a second plurality of compacted glove pairs, each compacted glove pair of the second plurality of compacted glove pairs comprising a first glove and a second glove,
wherein the gloves of the second plurality of glove pairs comprise a different type of glove than the gloves of the first plurality of glove pairs.

21. The system of claim 20, wherein the first dispensing container further comprises a second interior compartment and a second dispensing opening associated with the second interior compartment and wherein the second plurality of pouches are stored within the second interior compartment and are dispensed from, the second interior compartment through the second dispensing opening.

22. The system of claim 21, wherein at least one of the first plurality or second plurality of pouches further comprises at least one differentiating indicia.

23. The system of claim 20, further comprising a second dispensing container, wherein the second plurality of pouches are stored within and dispensed from the second dispensing container.

24. The system of claim 23, wherein at least one of the first plurality of pouches, the second plurality of pouches, the first dispensing container, or the second dispensing container further comprises at least one differentiating indicia.

25. The system of claim 23, further comprising a mount, the mount adapted to non-permanently affix more than one dispensing container to a support surface.

26. A system for providing glove pairs to a user, the system comprising:
a first plurality of compacted glove pairs;
a second plurality of compacted glove pairs, wherein the gloves of the second plurality of compacted gloves comprise a different type of glove than the gloves of the first plurality of compacted gloves;
a first plurality of pouches that contain and protect the individual glove pairs of the first plurality of glove pairs, wherein each of the pouches further comprise at least one differentiation indicia that indicates the type of glove pair contained within the pouch,
a second plurality of pouches that contain and protect the individual glove pairs of the second plurality of glove pairs, where each of the pouches further comprise at least one differentiation indicia that indicates the type of glove pair contained within the pouch, and
a set of instructions that help the user select the appropriate glove pair type.

27. The system of claim 26, further comprising a first dispensing container comprising a first interior compartment and a first dispensing opening associated with the first interior compartment wherein the first plurality of pouches are stored within the first interior compartment and are dispensed from, the first interior compartment through the first dispensing opening.

28. The system of claim 27, wherein the instructions are associated with the first dispensing container.

29. The system of claim 27, wherein the first dispensing container further comprises a second interior compartment and a second dispensing opening associated with the second interior compartment, wherin the second plurality of pouches are stored within the second interior compartment and are dispensed from the second interior compartment, through the second dispensing opening.

30. The system of claim 27, further comprising a second dispensing container in which the second plurality of pouches are stored and dispensed therefrom.

31. The system of claim 30, wherein the instructions are associated with the first and second dispensing container.
